(19) United States
(12) Patent Application Publication
(10) Pub. No.: US 2010/0299613 A1
(43) Pub. Date: Nov. 25, 2010

(54) Method for the provision of a convergent messaging service for at least one terminal in a mobile radio network system and corresponding working unit

(76) Inventor: Matthias Röbke, Koln (DE)

Correspondence Address: SHLESINGER, ARKWRIGHT & GARVEY LLP, 5845 Richmond Highway, Suite 415, ALEXANDRIA, VA, 22303, US

(21) Appl. No.: 12/311,291

(22) PCT Filed: Sep. 27, 2007
(86) PCT No.: PCT/EP2007/008400

§ 371 Date: May 6, 2009

(30) Foreign Application Priority Data
Sep. 27, 2006 (DE) 10 2006 047.114.8

(51) Int. Cl. G06F 3/01

(52) U.S. Cl. 715/752

(57) ABSTRACT

The present invention relates to a method for the provision of a convergent messaging service for at least one terminal in a mobile radio network system wherein at the at least one terminal, a working unit (2) having a client function is set up which is designed to communicate with at least one network (1) of the mobile radio network system providing the convergent messaging service. Furthermore, the present invention provides a suitable working unit.

The present invention relates to a method for the provision of a convergent messaging service for at least one terminal in a mobile radio network system. Furthermore, the present invention relates to a working unit suitable for the provision of a convergent messaging service for at least one terminal in a mobile radio network system. The present invention also relates to a computer program product and a corresponding computer program.

### STATE OF THE ART

In the mobile radio technology, different messaging services are known today. These messaging services include among others SMS (Short Message Service), MMS (Multimedia Messaging Service), IM (Instant Messaging) and mobile email as well as Push-To-Talk. These different messaging services are presently built as individual so-called silos, meaning that each of these services exists virtually independently from the respective other services. This silo approach will be replaced by a so-called “convergent messaging” approach in the foreseeable future, however. In order to realize such a convergent messaging service, a corresponding working unit having a suitable so-called client function has to be present at the corresponding mobile radio terminal.

An object of the present invention is to provide a method and a working unit, respectively, enabling to request and to be provided with a convergent messaging service by means of a terminal in a mobile radio network system.

### SUMMARY OF THE INVENTION

To attain the above-mentioned object, the present invention provides a method for the provision of a convergent messaging service for at least one terminal in a mobile radio network system with the characteristics of claim 1 and a suitable working unit with the characteristics of claim 10. Further-more, the present invention discloses a computer program and a computer program product suitable for attaining the above-mentioned object.

According to claim 1 of the present invention, a method for the provision of a convergent messaging service for at least one terminal in a mobile radio network system is provided. Thereby, at the at least one terminal, a working unit having a client function is set up which is designed to communicate with at least one network of the mobile radio network system providing the convergent messaging service. In the scope of the present invention, a client function means the possibility of providing a connection with a service, in the present case especially with a convergent messaging service, so as to be able to request the services provided in it. Such services include, for example, downloading files, sending or receiving messages or other activities at corresponding databases.

It is conceivable that the working unit generates messages and sends them to the network of the mobile radio network system providing the convergent messaging service, the messages being conformal to requirements of the network providing the convergent messaging service.

Furthermore, it is conceivable in this respect that the working unit can communicate with each network of the mobile radio network system providing a convergent messaging service.

According to a possible embodiment of the method according to the invention, the working unit is stored and operated in a memory of the terminal at a SIM card of a user of the terminal and/or at an external medium that can be connected to the terminal.

It is conceivable that the working unit having the client function for communication with the at least one network of the mobile radio network system providing the convergent messaging service provides a user of the terminal with a first user interface designed for one of the services converged in the convergent messaging service. This means that the user interface provided by the working unit corresponds to the user interface of a familiar messaging service such as SMS or MMS. Thus, the user is able to use the services familiar to him in a usual manner without being aware of the fact or without having to be aware of the fact that in reality the communication is performed over the convergent messaging service. This means that the actual communication and its implementation, respectively, remain concealed to the user. Thus, the user is not required to deal with a new user interface, but he can communicate with the service familiar to him by the functions familiar to him.

Furthermore, in another embodiment of the method according to the invention, it is conceivable that the working unit for communication with the at least one network of the mobile radio network system providing the convergent messaging service provides a user of the terminal with a second user interface allowing the user to use any messaging options provided by the convergent messaging service over the working unit. This means that the user is given the possibility to use the convergent messaging service in its full scope. Thus, the user is able to use all messaging options, for example “Messaging Properties”, such as, for example, text messages, image messages, instant messages etc. provided by the convergent messaging service by the working unit having the client function according to the invention. This means that the working unit having the client function provided here has a generic character.

Furthermore, in another embodiment of a method according to the invention, it is conceivable that the working unit for communication with the at least one network of the mobile radio network system providing the convergent messaging service can provide a user of the terminal optionally with the first or the second user interface.

The convergent messaging service can converge, for example, services from the group consisting of SMS, MMS, EMS, IM, and Push-To-Talk.

Furthermore, the present invention provides a working unit for the provision of a convergent messaging service for at least one terminal in a mobile radio network system, wherein the working unit has a client function, is to be coupled functionally with the at least one terminal and is designed to communicate with at least one network of the mobile radio network system, the at least one network providing the convergent messaging service.

It is conceivable that the working unit can generate messages and send them to the network of the mobile radio network system providing the convergent messaging service for requesting the convergent messaging service, the messages being conformal to requirements of the network providing the convergent messaging service. Furthermore, it is conceivable in this respect that the working unit can communicate with each network of the mobile radio network system providing a convergent messaging service. Thus, the working unit represents a generic working unit being suitable not only to communicate with a particular network of the mobile radio network system providing a convergent messaging service but to exchange messages with all networks of the mobile radio network system providing a convergent messaging service.

According to another embodiment of the working unit according to the invention, the working unit is stored and to be operated at a SIM card of a user of the terminal and/or at an external medium that can be connected to the terminal.

It is conceivable that the working unit having the client function for communication with the at least one network of the mobile radio network system providing the convergent messaging service can provide a user of the terminal with a first user interface designed for one of the services converged in the convergent messaging service.

Thus, a user is given the possibility to use the service(s) familiar to him in a usual manner without having to know that the requested communication is actually performed over a convergent messaging service or over the network of the mobile radio network system providing the convergent messaging service.

Furthermore, it is conceivable that the working unit having the client function for communication with the at least one network of the mobile radio network system providing the convergent messaging service can provide a user of the terminal with a second user interface allowing the user to use any messaging options provided by the convergent messaging service over the working unit. Thus, the user is able to use all messaging properties, such as, for example, text messages, image messages, and/or so called instant messages provided by the convergent messaging service. This means that the working unit and its client function, respectively, has a generic character and is not specified for a particular service or depends upon this.

It is conceivable that the second user interface for communication with the at least one network of the mobile radio system providing the convergent messaging service is identically realized for any kind of message which is generated and sent or received.

Furthermore, it is conceivable that the working unit for communication with the at least one network of the mobile radio network system providing the convergent messaging service can provide a user of the terminal optionally with the first or the second user interface.

The convergent messaging service converges, for example, at least services from the group consisting of SMS, MMS, EMS, IM, and Push-To-Talk.

The present invention also relates to a computer program having program code means, with the help of which all steps of a method according to the invention can be performed when the computer program is executed on a computer or a corresponding calculating unit, particularly using a working unit according to the invention.

Also provided is a computer program product with a computer readable medium and a computer program stored at the computer readable medium having program code means suitable for executing all steps of a method according to the invention, when the computer program is executed on a computer or a corresponding calculating unit, particularly using a working unit according to the invention.

Other advantages and implementations of the invention will be derived from the specification and the included drawings.

It is understood that the characteristics mentioned above and the characteristics to be explained herein after can be applied not only in the respective indicated combination but also in other combinations or separately without leaving the scope of the present invention.

### SHORT DESCRIPTION OF THE DRAWINGS

The invention is illustrated schematically with respect to an embodiment in the drawings and will be described below in further details with reference to the drawings.

FIG. 1 shows a schematic view of a possible implementation of an embodiment of a method according to the invention;

FIG. 2 shows a schematic view of another possible implementation of another embodiment of the method according to the invention.

### DETAILED DESCRIPTION OF THE DRAWINGS

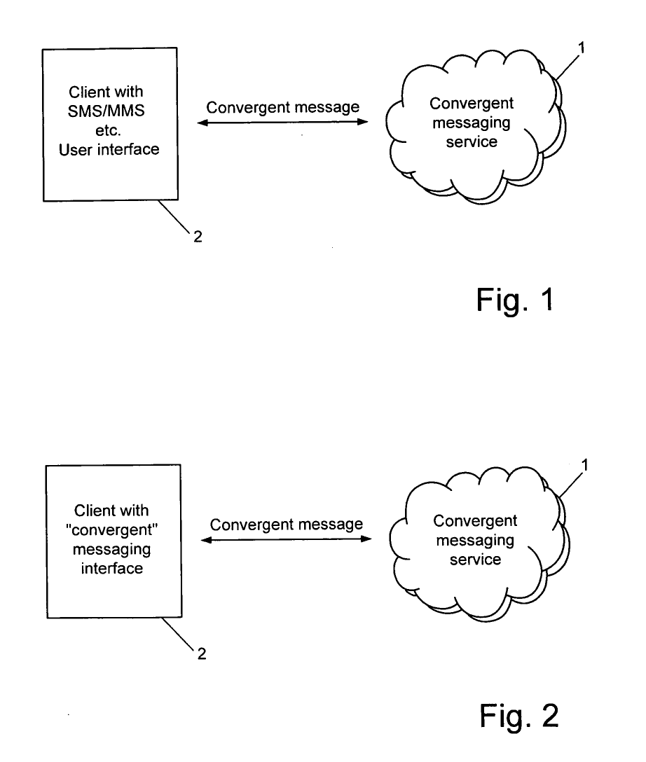

FIG. 1 is a schematic view of a possible implementation of a method according to the invention.

Thereby, a network 1 of the mobile radio network system providing a convergent messaging service is represented as a cloud. Furthermore, a working unit with a client function is represented as a rectangular box 2. Here, the working unit 2 is designed so that a terminal not shown here and communicating with the working unit 2 can communicate with the network 1 of the mobile radio network system providing the convergent messaging service via the working unit 2. Here, the implementable communication is shown by a double arrow symbolizing the communication path and the communication return path, respectively, over which messages between the terminal and the network 1 providing the convergent messaging service can be exchanged. The working unit 2 illustrated here provides a user interface to a user of the terminal not shown here corresponding to a user interface for familiar messaging services, such as, for example, SMS or MMS. Hereby, the user of the terminal is able to use the services familiar to him, such as, for example, SMS or MMS, in a usual manner, without being aware of the fact that in reality a communication is performed over a convergent messaging service as symbolized by the double arrow. This enables the user to use the convergent messaging service without further training or adaptation.

FIG. 2 shows a schematic view of a further possible implementation of another embodiment of the method according to the invention. Here, too, a network 1 providing a convergent messaging service is shown in form of a cloud. Furthermore, a working unit 2 with a client function is represented as a rectangular box. The working unit 2 which is to be coupled to a terminal not shown here can communicate with the network 1 providing the convergent messaging service which is again symbolized by a double arrow. In the embodiment of the working unit 2 shown here, the working unit provides a user of the not shown terminal with a user interface which enables the user of the terminal to use the convergent messaging service in its full scope. Thus, the user is able to use all messaging options provided by the convergent service via the working unit 2. These can be text messages, image messages or so called instant messages, for example. This means that the working unit or in particular the client function associated with the working unit has a generic character, i.e. it is neither related to a specific service converged in the convergent messaging service nor depends upon this. Furthermore, it is conceivable that the user interface is identical for any message being sent or received.

It is also conceivable that the working unit 2 optionally provides a user of a terminal not shown here with a user interface such as the one shown in FIG. 1 or with a user interface such as the one shown in FIG. 2. It is possible that such a setting can also be preset at the terminal or directly at the working unit 2. The working unit 2 having the client function can furthermore be directly implemented at the terminal which means that it can be stored in a memory of the terminal, for example. Furthermore, the working unit can also be stored at an external medium to be connected to the terminal and operated from there. It is also possible that the working unit having the client function is stored at a SIM card of the user of the terminal and operated from there, as soon as the SIM card is input into the terminal.

1-20. (canceled)

21. A method for the provision of a convergent messaging service for at least one terminal in a mobile radio network system, comprising:
at the at least one terminal, a working unit having a client function is set up which is designed to communicate with at least one network of the mobile radio network system the at least one network providing the convergent messaging service; and
wherein the working unit having the client function for communication with the at least one network of the mobile radio network system providing the convergent messaging service providing a user of the terminal with a first user interface designed for one of the services converged in the convergent messaging service and with a second user interface allowing the user to use any messaging options provided by the convergent messaging service over the working unit.

22. The method according to claim 21 wherein the working unit can generate messages and send them to the network of the mobile radio network system providing the convergent messaging service, the messages being conformal to requirements of the network providing the convergent messaging service.

23. The method according to claim 21 wherein the working unit can communicate with any network of the mobile radio network system providing a convergent messaging service.

24. The method according to claim 21 wherein the working unit having the client function for communication with the at least one network of the mobile radio network system providing the convergent messaging service provides a user of the terminal with a second user interface allowing the user to use any messaging options provided by the convergent messaging service over the working unit.

25. The method according to claim 21 wherein the second user interface for communication with the at least one network of the mobile radio network system providing the convergent messaging service is identically realized for any kind of message which is generated and sent or received.

26. The method according to claim 21 wherein the working unit for communication with the at least one network of the mobile radio network system providing the convergent messaging service provides a user of the terminal optionally with the first or the second user interface.

27. The method according to claim 21 wherein the convergent messaging service converges at least services from the group consisting of SMS, MMS, EMS, IM, and Push-To-Talk.

28. A working unit for the provision of a convergent messaging service for at least one terminal in a mobile radio network system:
wherein the working unit has a client function, is to be coupled functionally with the at least one terminal and is designed to communicate with at least one network of the mobile radio network system providing the convergent messaging service; and
wherein the working unit having the client function for communication with the at least one network of the mobile radio network system providing the convergent messaging service can provide a user of the terminal with a first user interface designed for one of the services converged in the convergent messaging service and with a second user interface allowing the user to use any messaging options provided by the convergent messaging service over the working unit.

29. A working unit according to claim 28 wherein the working unit can generate messages and send them to the network of the mobile radio network system providing the convergent messaging service, the messages being conformal to requirements of the network providing the convergent messaging service.

30. The working unit according to claim 28 wherein the working unit can communicate with any network of the mobile radio network system providing a convergent messaging service.

31. The working unit according to claim 28 wherein the working unit is stored and to be operated in a memory of the terminal, at a SIM card of a user of the terminal and/or at an external medium that can be connected to the terminal.

32. The working unit according to claim 28 wherein the second user interface for communication with the at least one network of the mobile radio network system providing the convergent messaging service is identically realized for any kind of message which is generated and sent or received.

33. The working unit according to claim 28 wherein the working unit for communication with the at least one network of the mobile radio network system providing the convergent messaging service can provide a user of the terminal optionally with the first or the second user interface.

34. The working unit according to claim 28 wherein the convergent messaging-service converges at least services from the group consisting of SMS, MMS, EMS, IM, and Push-To-Talk.

35. A computer program having program code means, with the help of which all steps of a method according to claim 21 can be performed when the computer program is run on a computer or a corresponding calculating unit.

36. A computer program with a computer readable medium and a computer program stored at the computer readable medium having program code means suitable for executing all steps of a method according to claim 21, when the computer program is run on a computer or a corresponding calculating unit.
